(19) United States
(12) Patent Application Publication
(10) Pub. No.: US 2003/0101342 A1
(43) Pub. Date: May 29, 2003

(54) Secure printing system and method

(76) Inventor: Von L. Hansen, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/995,777

(22) Filed: Nov. 29, 2001

(51) Int. Cl. H04L 9/00; H04L 9/32

(52) U.S. Cl. 713/167

(57) ABSTRACT

A printing method comprises placing a mobile computing device within a select proximity of a printer and sending from the mobile computing device to the printer a security key and printing instructions to enable the printer to access and print the document. A printing system comprises a printer, a mobile computing device for holding a security key and instructions for printing the document and having a communication module for activating the printer to print the document when the mobile computing device is within a select proximity of the printer.

### THE FIELD OF THE INVENTION

The present invention relates generally to computer-based printing systems, and in particular, to a computer-based secure printing system.

### BACKGROUND OF THE INVENTION

With the advent of the computer revolution, our view of computer resources has evolved. Historically, some computer resources were hard to come by. For example, in early stages of computer use, a single printer commonly was shared among dozens or even hundreds of users with the printer often being located far from the user's computing station. Eventually, computer users could access printers connected to their own personal computer or connected closely to their workstation within a network of computers. With the closeness of the printer to the computing station, the user could quickly retrieve a printed document from the printer. If desired, the user preserved the confidentiality of the printed document by being present while the document was printed.

With the growth of the network computing and the Internet, a computer user can not only print a document in their home or business, but can print it in other locations as well. For example, an employee can send a print job to a printer in another building of the employer for reception by that employee or another employee. In another example, a user can send a print job to a commercial printer (e.g., Kinkos®) that receives the print job and prints the job at a selected location (e.g., a printing retailer in a selected city). In this case, the print job is handled securely by the commercial printer while in electronic form, making it difficult for printer employees or other interveners to view the job prior to printing. However, as soon as the job is printed, an employee of the commercial printer or a third party could potentially view the document. Similarly, within an employer's network, anyone standing by the printer can view the document as it is printed, unless the intended recipient or user is present.

While convenience is gained with commercial printers providing nationwide printing services or with employers providing network-wide printing, a price is paid in the loss of confidentiality. Privacy of the information can be easily lost once the information hits the printed page. Accordingly, the promise of nationwide commercial printing services or multi-location network printing systems falls short because of a lack of confidentiality and control over the printed page or document.

### SUMMARY OF THE INVENTION

A printing method of the present invention comprises placing a mobile computing device within a select proximity of a printer and sending from the mobile computing device to the printer a security key and printing instructions to enable the printer to access and print a document. A printing system of the present invention comprises a printer and a mobile computing device for holding a security key and instructions for printing a document. The mobile computing device has a communication module for activating the printer to access and print the document when the mobile computing device is within a select proximity of the printer.

### BRIEF DESCRIPTION OF THE DRAWINGS

FIG. 1 is block diagram of a printing system of the present invention.

FIG. 2 is a flow diagram of a printing method of the present invention.

FIG. 3 is block diagram of user interface of a printing system of the present invention.

FIG. 4 is block diagram of a commercial printing system of the present invention.

FIG. 5 is a block diagram of a network environment printing system of the present invention.

FIG. 6 is a flow diagram of a secure printing method of the present invention.

FIG. 7 is block diagram of a service facility printing system of the present invention.

FIG. 8 is a block diagram of an information printing system of the present invention.

### Description of the Preferred Embodiments

In the following detailed description of the preferred embodiments, reference is made to the accompanying drawings which form a part hereof, and in which is shown by way of illustration specific embodiments in which the invention may be practiced. It is to be understood that other embodiments may be utilized and structural or logical changes may be made without departing from the scope of the present invention. The following detailed description, therefore, is not to be taken in a limiting sense, and the scope of the present invention is defined by the appended claims.

Components of the printing method and system of the present invention can be implemented in hardware via a microprocessor, programmable logic, or state machine, in firmware, or in software within a given device. In one aspect, at least a portion of the software programming is web-based and written in HTML and JAVA programming languages, including links to graphical user interfaces for data collection, such as a windows based operating system, and each of the main components may communicate via a network using a communication bus protocol. For example, the present invention may or may not use a TCP/IP protocol suite for data transport. Other programming languages and communication bus protocols suitable for use with the present invention will become apparent to those skilled in the art after reading the present application. Components of the present invention may also reside in software on one or more computer-readable mediums. The term computer-readable medium as used herein is defined to include any kind of memory, volatile or non-volatile (e.g., floppy disks, hard disks, CD-ROMs, flash memory, read-only memory (ROM), and random access memory (RAM)).

Preferably, the user interfaces described herein run on a controller, computer, appliance or other device having an operating system which can support one or more applications. The operating system is stored in memory and executes on a processor. The operating system is preferably a multi-tasking operating system which allows simultaneous execution of multiple applications, although aspects of this invention may be implemented using a single-tasking operating system. The operating system employs a graphical user interface windowing environment which presents the applications or documents in specially delineated areas of the display screen called “windows.” Each window has its own adjustable boundaries which allow the user to enlarge or shrink the application or document relative to the display screen. Each window can act independently, including its own menu, toolbar, pointers, and other controls, as if it were a virtual display device. Other software tools may be employed via the window, such as a spreadsheet for collecting data. The operating system preferably includes a windows-based dynamic display which allows for the entry or selection of data in dynamic data field locations via an input device such as a keyboard and/or mouse. One preferred operating system is a Windows® brand operating system sold by Microsoft Corporation. However, other operating systems which provide windowing environments may be employed, such as those available from Apple Corporation or IBM. In another embodiment, the operating system does not employ a windowing environment.

Printing system 10 of the present invention includes printing station 12, information holding station 14, mobile computing device 16, computer workstation 18, and network communication link 20. Printing station 12 includes printer 30 with Java Virtual Machine (JVM) 31 and computer system 32 having display 34, memory 36, and controller 38. Information holding station 14 further includes secure server 40 with controller 42.

Printing system 10 includes user interface 17 (e.g., a graphical user interface) operating on mobile computing device 16 (and/or computer workstation 18, computer system 32) to operate printing system 10. User interface 17 can be implemented in hardware via a microprocessor, programmable logic device, or state machine, and firmware, or in software within a given device. In one aspect, at least a portion of the software programming is written in Java programming language, and user interface 20 communicates with printing station 12 via network communication link 20 using a communication bus protocol. For example, the present invention optionally can use a TCP/IP protocol suite for data transport. In another aspect, the present invention does not use a TCP/IP protocol suite for data transport. Other programming languages and communication bus protocols suitable for use with printing system 10 will be apparent to those skilled in the art.

Network communication link 20, as used herein, includes an Internet communication link, an intranet communication link, or similar high-speed communication link. In one preferred embodiment, network communication link 20 includes Internet communication link 44. Network communication link 20 permits communication between mobile computing device 16 (with user interface 17), printing station 12 and information holding station 14.

Mobile computing device 16 is preferably a handheld and/or wireless mobile computing device such as a handheld or notebook computer, personal digital assistant, or mobile phone. Both mobile computing device 16 and printing station 12 further include wireless communication module 43, so that when mobile computing device 16 is within sufficiently close proximity to the printing station 12, printing station 12 and mobile computing device 16 communicate with each other to identify a printer 30 that is available. Upon printer identification and user authorization, mobile computing device 16 transmits a security key and printing instructions to printer 30, as will be more fully described later.

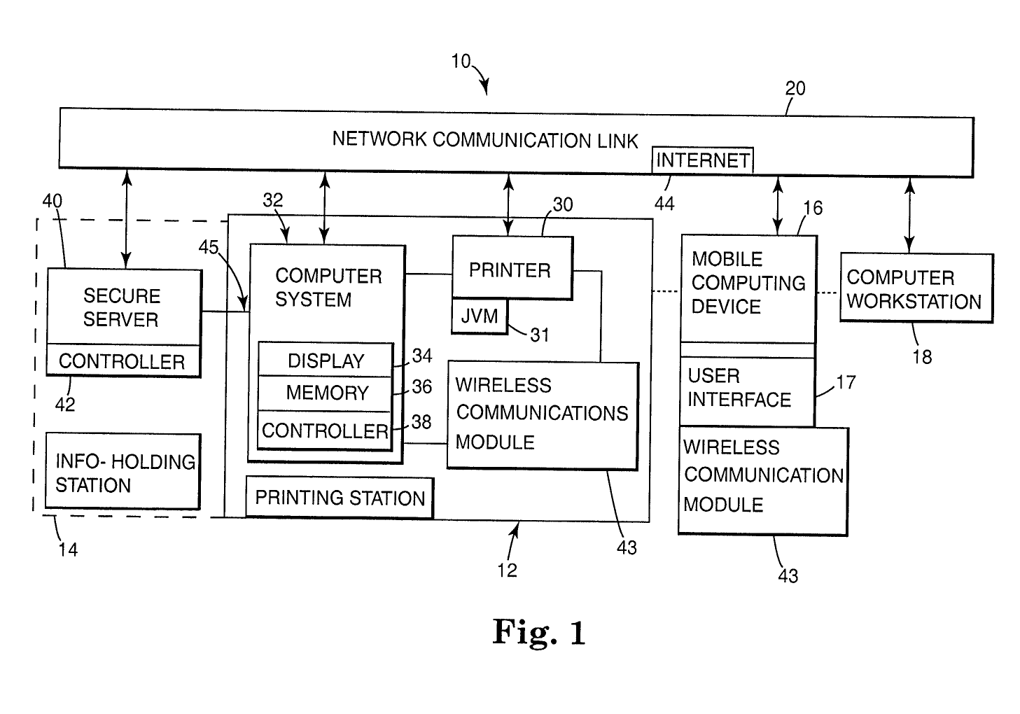

Wireless communication between mobile computing device 16 and printing station 12 is accomplished using one or more known communication and application protocols such as Wireless Application Protocol (WAP), Bluetooth, Infrared (IrDA, FIR), 802.11 as well as other communication and application protocols known to those skilled in the art. Mobile computing device 16 and printing station 12 each include communication hardware and software known in the art for implementing these protocols, such as wireless communication module 43. In printing station 12, wireless communication module 43 is included in printer 30, computer system 32, or both. Alternatively, wireless communication module 43 is independent of printer 30 and computer system 32 and in coupled communication with printer 30 and/or computer system 32, as shown in FIG. 1.

Of particular interest are protocols such as FiR and Bluetooth which permit direct radio or beamed communication between compatible devices that operate independently of a network and independently of network communication link 20. This feature permits direct one-on-one communication between a business and a consumer without any communication intermediary. In the example of the Bluetooth protocol, the communication link preferably is established by the mere presence of each respective device (e.g., mobile computing device 16 and printing station 12 with printer 30) in close proximity to each other. This instant synchronization enables users to immediately communicate with each other without taking time to manually establish a connection or communication link. Of course, mobile computing device 16 and/or printing station 12 also can retain selective control of when any communications link is established (or recognized) so that undesirable communication linking (by third party interveners) to mobile computing device 16 and/or printing station 12, respectively, is prevented. Finally, mobile computing device 16 also can communicate with printing station 12 through more conventional indirect routes such as wireless network links, wired or wireless internet links, or telecommunications networks.

Printer 30 preferably includes Java Virtual Machine 31 and preferably use Java programming language so that JVM 31 of printer 30 can receive a Java applet from mobile computing device 16 or computer workstation 18 to dynamically reprogram printer 30 on a limited basis to perform a task such as completing a requested print job. Alternatively, instead of JVM 31, printer 30 is equipped with a different device independent-type programming language controller for receiving and operating with device independent type programming languages, as known to those skilled in the art.

Computer system 32 preferably is a microprocessor based computing device. Computer system 32 of printing station 12 uses controller 38 that includes hardware, software, firmware or combination of these. In one preferred embodiment controller 38 includes a computer server or other microprocessor based system capable of performing a sequence and logic operation and including memory 36 for storing information. In addition, controller 38 can include a microprocessor embedded systems/appliance incorporating tailored appliance hardware and/or dedicated single purpose hardware.

Information holding station 14 comprises a network-based or nonnetwork-based station for holding information such as documents for printing at printing station 12. Documents include anything printable by a printer. Information holding station 14 can be located with, and communicate directly with, printing station 12 through direct link 45. Alternatively, information holding station 14 is located remotely from printing station 12 and communicates with printing station 12 through network communication link 20. Secure server 40 acts to hold documents in storage and communicates with one or more printing stations 12 to supply documents for printing upon request. In this way, information holding station 14 acts a network printing manager to handle printing requests among one or more printing stations 12. Moreover, multiple information holding stations 14 optionally are connected together to define the network printing manager as a network of information holding stations 14. Secure computer server 40 of information holding station 14, with controller 42, includes substantially the same features as controller 38 and computer system 32.

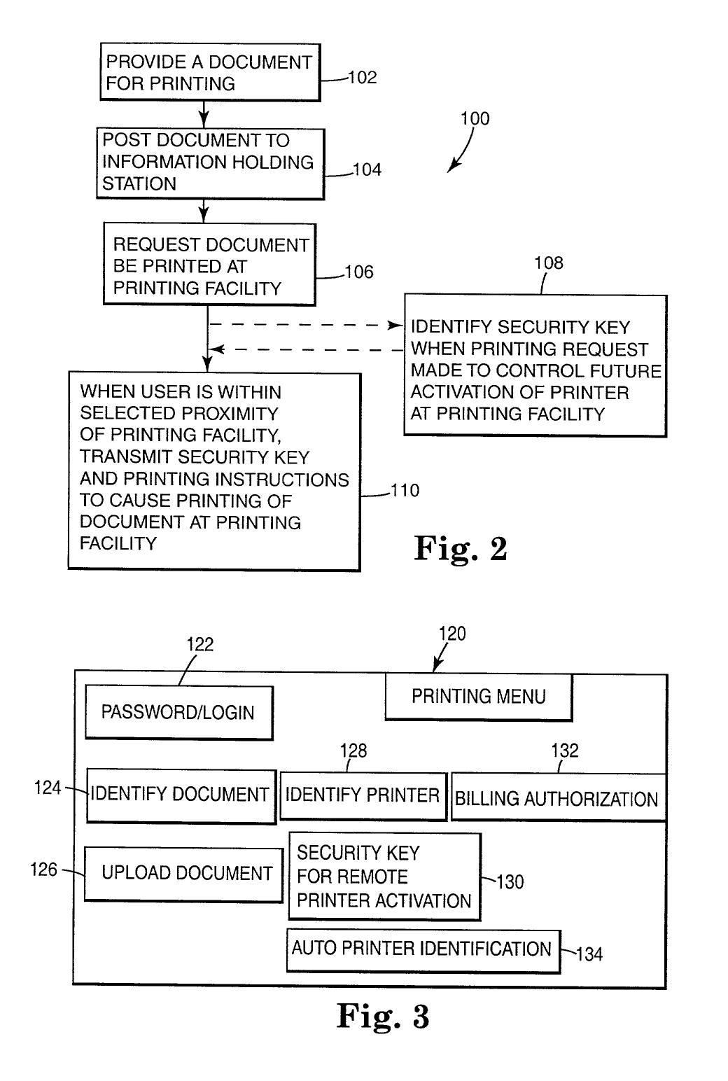

A printing method 100 of the present invention that uses printing system 10 is illustrated generally in FIG. 2. Method 100 includes a first step of providing a document for printing (step 102) and then posting the document to information holding station 14 (step 104) for storage in secure server 40. For example, mobile computing device 16 and/or computer workstation 18 are used to send the document electronically to information holding station 14, associated with printing station 12. The document sits at information holding station 14 until a print request is made. While the document is preferably sent via network communication link 20 (wired or wirelessly), mobile computing device 16 is capable of wirelessly transmitting the document directly to information holding station 14 and/or printing station 12.

Next, mobile computing device 16 and/or computer workstation 18 submits a request that the document be held at server 40 for printing at a printing facility such as printing station 12 (step 106). When mobile computing device 16 is carried by a user within a select proximity of printing station 12, the user wirelessly transmits a security key with printing instructions from mobile computing device 16 to printer 30 to activate printer 30 for printing the document at printing station 12 (step 110). The security key insures that only the authorized user of mobile computing device 16, with consent of printing station 12, accesses the document on server 40 of information holding station 14 and print document on printer 30. The security key comprises a conventional password, digital signature or ID, or some other encryption system in which one or more passwords or signatures are used to create a unique identifier to permit access to the secured document only by the owner/operator of the unique identifier. The printing instructions specify the server address or other location of the document, as well as how, when, and where the document will be printed in association with printing station 12. As will be described in further detail later, mobile computing device 16 and printing station 12 employ a device independent type language, such as Java or others known to those skilled in the art, with a device independent program controller (e.g. Java Virtual Machine) to exchange the security key and printing instructions.

The method optionally includes the further step of pre-identifying the security key (when the printing request is made in step 106) in anticipation of activation of printer 30 by mobile computing device 16 at the printing station 12 (step 108).

Moreover, using a security key and/or placing mobile computing device 16 within a select proximity of printing station 12 are not the only ways to insure that printing a document is an authorized action. For example, only certain mobile computing devices 16 can be designated as authorized to engage printer based on their identity. Likewise, only certain authorized types of wireless transmissions or only certain identified wireless transmissions are optionally capable of engaging printing station 12. Finally, time (duration, time of day, day of week, etc.) can be used as factor in determining whether to allow selective printing at printing station 12.

As shown in FIG. 3, user interface 17 displays printing menu 120 to enable communication with printing station 12 and information holding station 14 (i.e., network printing manager) for printing a document at printing station 12. Printing menu 120 is accessed by mobile computing device 16, computer workstation 18, and/or printing station 12. Printing menu 120 preferably forms part of a software based printing service operated by printing station 12 and information holding station 14. Printing menu 120 includes password/login function 122, identify document function 124, upload document function 126, identify printer function 128, security key function 130, billing authorization 132, and auto printer identification 134.

Password/login function 122 permits confidential access to printing system 10, which is pre-arranged between the user and the operator/owner (commercial retailer or employer) of printing station 12. Identify document function 124 permits a user to identify a document for printing while upload document function 126 allows the user to upload the document to a server (e.g. secure server 40 in FIG. 1) or web site for printing to another location. Identify printer function 128 permits the user to identify a specific printer (e.g. printer 30 at printing station 12) including the printer's geographic location (e.g., business location, store, city/state, or employer's building, department, etc.).

Security key function 130 permits the user to identify a security key associated with their printing job to permit the user to initiate and complete secure printing of the document upon the user later providing the security key to the selected printer. Billing authorization 132 permits the user to identify relevant billing information such name, business name, account number, credit card number, and/or other payment information to arrange payment to printing station 12 for the service of printing the document. Finally, auto printer identification 134 optionally is activated so that once the user is within a select proximity of an available printer 30 at printing station 12, printing system 10 permits mobile computing device 16 to automatically identify the available printer and automatically initiate the printing sequence to print the document.

In a more detailed aspect of printing system 10 of the present invention, commercial printing system 150 of the present invention is illustrated generally in FIG. 4. As shown, commercial printing system 150 includes commercial printing entity 152, computer (e.g., workstation and/or mobile computing device) 154, network communication link 20, and mobile computing device 158. Mobile computing device 158 has substantially the same features as mobile computing device 16. Commercial printing entity 152 further includes secure server 160 with optional website 162. Multiple commercial printers 164 are associated with commercial printing entity 152 and include computing system 166 (e.g, workstation or personal computer) with Java Virtual Machine (JVM) 168.

System 158 comprises a commercial printing environment in which a user desires to print a confidential document at a commercial printer. The user must be present when the document is printed to insure its confidentiality.

In particular, computer 154 is used (via printing menu 120 and user interface 17) to identify the document and upload the document via network communication link 20 to secure commercial server 160 (via commercial website 162) for future printing. Next, the user optionally identifies which commercial printer 164 of commercial printing system 150 will print the document. Finally, the user approaches one of the commercial printers 164 with mobile computing devices 158 to print the document. When mobile computing device 158 is within a select proximity of commercial printer 164, mobile computing device 158 transmits to printer 164 a security key for accessing the document at server 160 along with instructions and authorization for printing the document (e.g. when, how, etc.) on commercial printer 164. Accordingly, the document is identified to commercial printer 164 at a first point in time but not printed until a second point in time when the user is within a select proximity of printer 164 to insure its confidentiality.

Alternatively, the user optionally chooses to not to identify the document at all until the user is within a select proximity of commercial printer 164. In this case, the mobile computing device 158 does not identify and post the document to the commercial server 160 until mobile computing device 158 is within the select proximity of commercial printer 164.

Communications between mobile computing device 158 and commercial printer 164 preferably occur wirelessly where the security key and printing instructions are sent to printer JVM 168 (or other device independent programming language machine) through a Java applet (or other device independent programming language program).

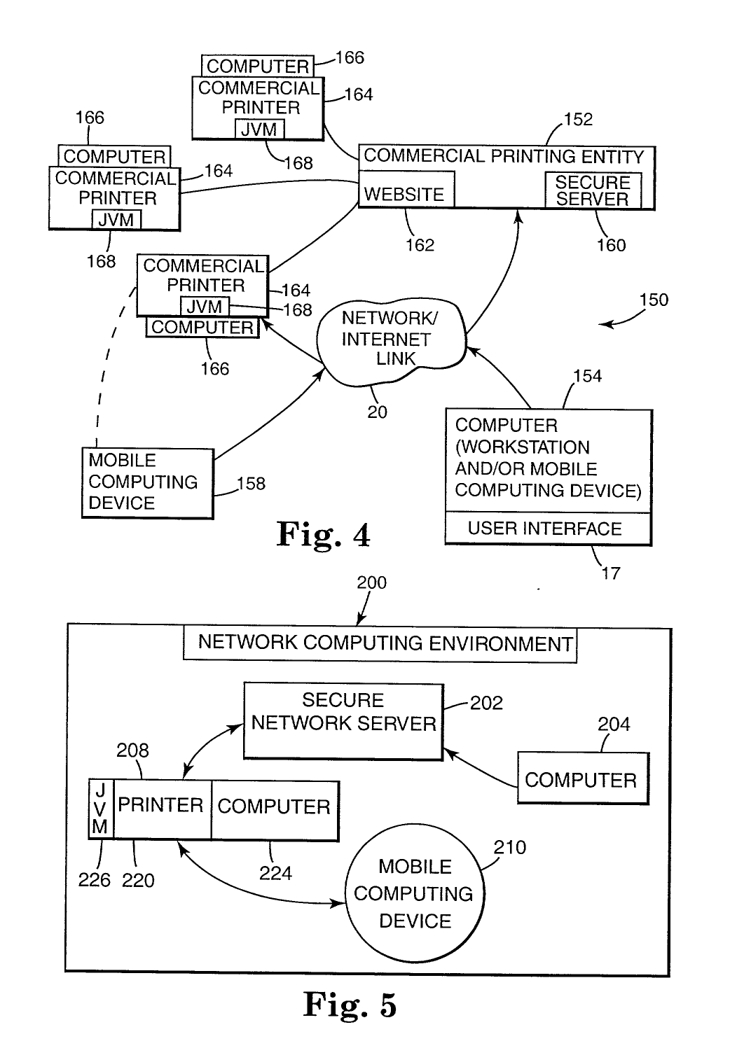

Network computing system 200 of the present invention is shown generally in FIG. 5 and includes secure network server 202, desktop computer 204, printing station 208, and mobile computing device 210. Printing station 208 includes printer 220 with JVM 222, and computer 224.

System 200 comprises a private network computing environment in which a user will print a document at a printer remote from their regular workstation and insure their presence as the document as printed to insure its confidentiality. For example, an employee in a business (or member in a private organization) identifies a print request to print an employee evaluation, financial information, wage/salary information at a remote printer where the printing is selectively delayed by the employee until the employee is in the proximity of the remote printer to safeguard the privacy of the information.

In particular, using desktop computer 204, a user identifies a document for printing and posts it on network server 202. At a later time, using mobile computing device 210, user approaches printing station 208. Mobile computing device 210 delivers to printing station 208 a security key and printing instructions to activate printer 220. With the support of computer 224, printer 220 obtains access to document from server 202 with the security key, retrieves the document, and then using the printing instructions, prints the document on printer 220. System 200 optionally includes an additional level of security in which after the printer gets the document and is prepared to print it, printing is not completed unless mobile computing device 210 has remained within select proximity of printer 220 and/or a second security key is passed to the printer from mobile computing device to confirm that printing can be completed.

Communications between mobile computing device 210 and printing station 208 preferably occur wirelessly where security key and printing instructions are sent to printer JVM 220 (or other device independent programming language machine) through a Java applet (or other device independent programming language program).

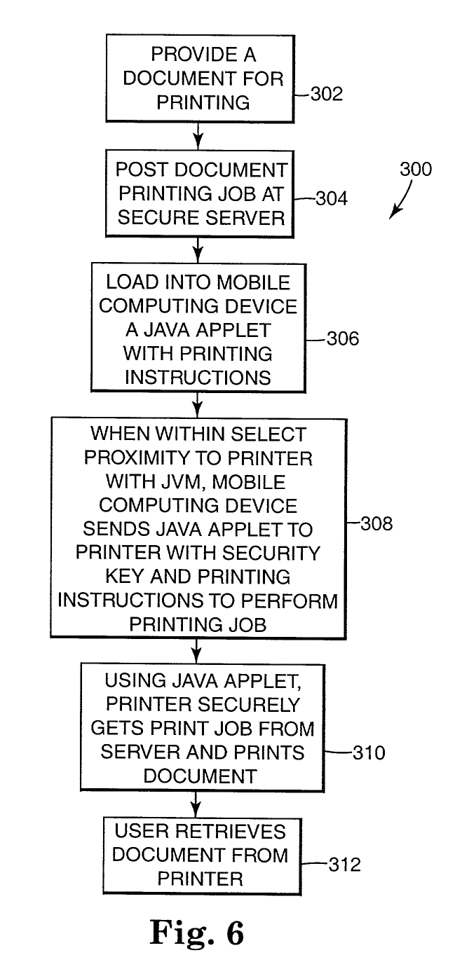

A printing method 300 of the present invention is shown generally in FIG. 6. Method 300 includes a first step of providing a document for printing (step 302). Next, the document is electronically posted as a printing job at a secure server (step 304). The electronic posting is performed by uploading the document, sending an email with the document as an attachment to a web-centric document server, and/or other protocols known in the art for transmitting a document electronically. A Java applet, including a security key and printing instructions, is then loaded into a mobile computing device (step 306). When the mobile computing device is within a select proximity to the printer, user sends the Java applet from the mobile computing device to the printer (step 308). The printing instructions include a server address or other location at which the printer can retrieve the printing job. The security key permits limited access to the printer for running the Java applet and for obtaining secure access to the document at the server address or other location.

Using the Java applet, the printer securely acquires the print job from the server and prints the document (step 310). Finally, the user immediately retrieves the document from the printer, thereby ensuring its confidentiality (step 312). The Java applet also optionally includes instructions to report to the mobile computing device either a confirmation of the printer successfully printing the document, or an error message that the printing job was not completed with suggested remedial actions to be taken.

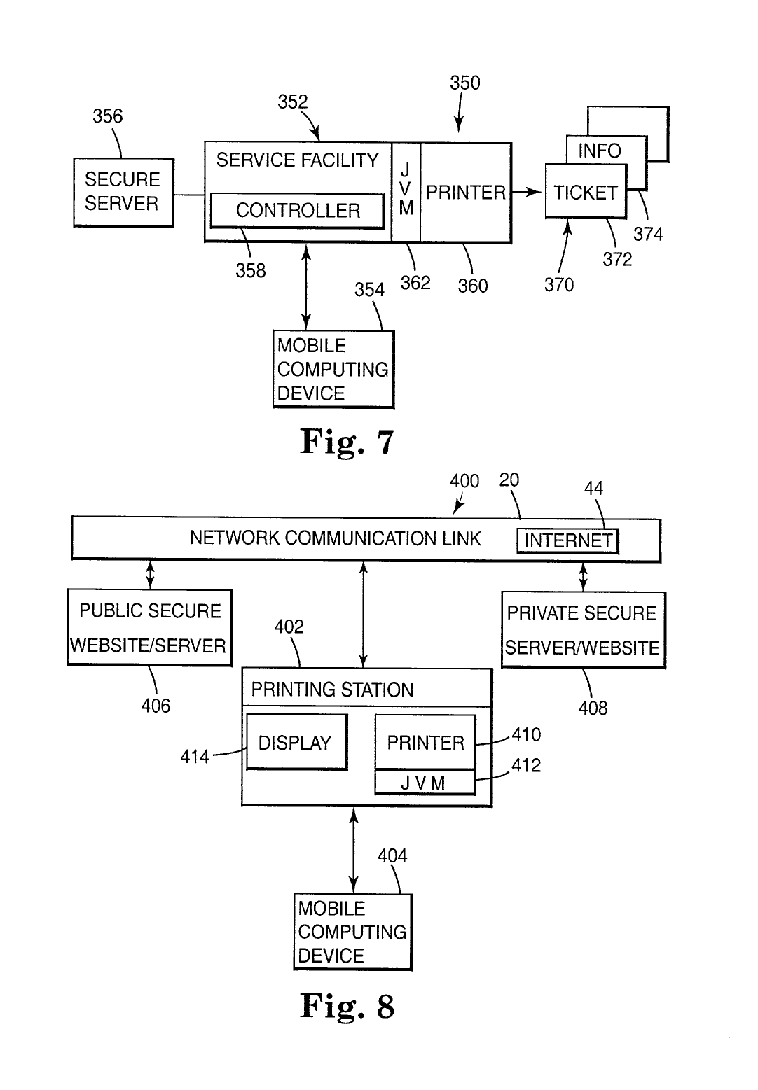

In another aspect of the invention, service printing system 350, shown in FIG. 7, comprises any service requiring printing of information as part of performing the service. For example, an airline ticket counter or check-in counter performs the service of ticketing, seat assignment, and optionally catering to personal preferences of the customer. In this situation, the customer typically goes to the counter to identify themselves and receive a ticket, seat assignment, etc. In conventional systems, most of this information already exists in a computer server of the airline company and simply must be recalled by the service counter when the presence of the passenger is confirmed.

Service printing system 350 includes service facility 352, mobile computing device 354, and secure server 356. Service facility 352 further includes controller 358, printer 360 with JVM 362 (or other device independent programming language machine). Finally, system 350 includes printed document 370 including ticket 372 and information 374. Server 356 holds all passenger information including ticketing, seat assignments, personal preferences, etc. Upon the arrival of the passenger at service facility 352, the passenger's mobile computing device 354 comes within a select proximity of service facility 352. Once within this select proximity, mobile computing device 354 and service facility 352 recognize each other, permitting wireless communication therebetween. Mobile computing device 354 sends a Java applet including a security key and service requests instructions to printer 360 with JVM 362. Following the commands of the Java applet, printer 360 instructs controller 358 to confirm the identity of the passenger via the security key, retrieve all passenger ticketing and personal profile information from server 356, and initiate printing document packet 370 on printer 360. Accordingly, printer 360 prints document packet 370, which includes ticket 372 and information 374. Information 374 can include a passenger selection of news, entertainment, etc.

To account for security concerns, the security key of mobile computing device 354 acts in cooperation of a security module of service facility 352 to insure that the correct passenger receives ticketing and that no unauthorized persons can access, modify, or alter the passenger's personal and ticketing information. Of course, after or before printing of document packet 270, service facility 352 such as an airline can also personally confirm the identity of the passenger and the ticketing information. Similarly, service facility 352 exerts control over the distance at which mobile computing device 354 is within sufficient proximity to communicate with service facility 352.

Service printing system 350 allows the user to quickly check-in at the service counter, bypassing routine conversation and idle waiting that exemplifies conventional interactions with service counters. In addition, service printing system 350 enables users of mobile computing devices 354 to obtain more premium services, such as information (news and entertainment) that is personal to the user.

In addition to airlines, service printing system 350 can be implemented in any service application requiring some form of secure printing as part of performing a service for a customer.

Public printing system 400 of the present invention is shown generally in FIG. 8. Public printing system 400 comprises a computing system in which a user will print a document at a publicly accessible printer and must insure their presence as the document is printed to insure confidentiality of the document. For example, a user such as a shopper or traveler may desire to print business information, personal financial information, or other private information at a publicly accessible printer, but only when the shopper, traveler is present at the publicly accessible printer to safeguard the privacy of the information.

Public printing system 400 includes printing station 402, mobile computing device 404, public website/server 406, private server/website 408, and network communication link 20 with Internet communication link 44. Printing station 402 includes printer 410 with JVM 412 and display 414.

In one example, printing station 402 comprises an information station located in a public venue, such as a kiosk in an airport or mall. The user posts a document at personal server/website 408 or commercial website/server 406 for printing at public printing station 402. Next, the user travels to the printing station 402 to print the document. Once the user's mobile computing device 404 is located within a select proximity of printing station 402, a security key and printing instructions are sent from mobile computing device 404 to JVM 412 of printing station 402. Following the printing instructions, printer 410 acquires a document at an identified location (e.g. private server/web site 408, or public server/website 406) and prints the document at printer 410.

A printing method and system of the present invention carries numerous advantageous features. Foremost, using a mobile computing device, a user can insure that a document is printed at a printer only when the user is within a select proximity of the printer to insure the confidentiality of the document as it is printed. This confidential control is implemented by the mobile computing device wirelessly transmitting to the printer a security key to permit authorized access to the document and authorized use of the printer, along with a set of printing instructions for the printer to carry out in printing the document. The document is located on the mobile computing device, or at a server accessible by the printer. In at least one aspect, the method and system is helpful in permitting confidential documents to be printed at publicly located printers wherein the document has been previously posted to a secure server for later printing at the public printer. Moreover, the security key need not be exclusively associated with a mobile computing device that is operated by the person who posted the document to the server. Rather, the security key can be further provided to another user, who can then in turn use their own mobile computing device or computer workstation to access to printer with a security key and thereby complete printing of the document from the server. In this way, a user can send a document to another user for printing only when the other user is present at the printer, all without giving the other user electronic access to manipulate the document before or after printing.

Although specific embodiments have been illustrated and described herein for purposes of description of the preferred embodiment, it will be appreciated by those of ordinary skill in the art that a wide variety of alternate and/or equivalent implementations may be substituted for the specific embodiments shown and described without departing from the scope of the present invention. Those with skill in the chemical, mechanical, electromechanical, electrical, and computer arts will readily appreciate that the present invention may be implemented in a very wide variety of embodiments. This application is intended to cover any adaptations or variations of the preferred embodiments discussed herein. Therefore, it is manifestly intended that this invention be limited only by the claims and the equivalents thereof.

What is claimed is:

1. A method of printing comprising:
placing a mobile computing device within a select proximity of a printer; and
sending from the mobile computing device to the printer a security key and printing instructions to enable the printer to access and print a document.

2. The method of claim 1, further comprising:
posting the document on a server as a print job for the printer; and
printing the print job only when the user activates the printer with the security key.

3. The method of claim 1, wherein the posting step further comprises:
accessing a network printing manager;
identifying the document for printing to the network printing manager; and
uploading the document to a server of the network printing manager.

4. The method of claim 3, wherein the accessing step further comprises:
providing the network printing manager as a commercial printing web site.

5. The method of claim 3, further comprising:
identifying a location of the printer associated with the network printing manager for printing the document.

6. The method of claim 1, wherein the sending step further comprises:
transmitting the security key by wireless communication including at least one of the following wireless communication protocols: infrared; Bluetooth; and WAP.

7. The method of claim 1, wherein the sending step further comprises:
transmitting computer program instructions from the mobile computing device to the printer to instruct the printer on how to print the document including a server address of the print job and the security key to authorize the printer to print the document.

8. The method of claim 7, wherein the transmitting step further comprises:
using a Java applet to transmit the printing instructions and security key; and
receiving and operating the Java applet with a Java virtual machine of the printer.

9. The method of claim 2, further comprising:
identifying the security key, which uniquely identifies the document print job, at substantially the same time the document is posted to the server for later use of the security key by the mobile computing device to selectively activate the printer.

10. A method of printing comprising:
carrying a document on a mobile computing device as a print job for a remote printer; and
printing the print job on the remote printer only when the user wirelessly activates the printer with a security key from a mobile computing device to cause transmission of the print job to the printer and to cause printing of the print job on the printer.

11. A method of printing comprising:
posting a print job on a server for printing at a printer;
selectively delaying the printing of the print job until the printer receives printing instructions from an authorized wireless transmission to the printer, wherein the printing instructions command the printer to access and perform the print job.

12. The method of claim 11 wherein the delaying step further comprises:
determining whether a wireless transmission is authorized based on at least one of a distance from a source of the wireless transmission to the printer, a time factor associated with the printer, and a type of wireless transmission.

13. A method of printing comprising:
providing a document in computer memory as a print job for a printer; and
activating the printer to print the document with a security key within a select proximity of the printer to retrieve the print job from the computer memory and print the print job.

14. A method of network printing comprising:
storing a document within a computing network for printing at at least one of a plurality of printers within the computing network;
identifying a mobile computing device with at least one printer within the computing network; and
sending from the mobile computing device to the at least one printer a security key and printing instructions to activate the at least one printer to retrieve and print the document.

15. A method of commercial network printing comprising:
selectively contracting with a commercial printing network to print a document at at least one of a plurality of printers within the commercial printing network;
posting a document on a server of the commercial printing network for printing on at least one of the printers in the commercial printing network;
sending from an authorized mobile computing device to at least one of the printers a security key and printing instructions to activate the at least one printer to retrieve and print the document.

16. A method of service printing comprising:
posting a service document, associated with a pre-identified consumer service, on a server of a service facility;
sending from a mobile computing device to a printer of the service facility a security key and instructions to request the pre-identified service and printing of the service document; and
delivering the pre-identified service to the consumer by printing the service document on the printer at the service facility.

17. The method of claim 16, further comprising:
creating an airline passenger ticket as the service document to provide the service of passenger airline travel for the consumer.

18. The method of claim 17, further comprising:
expanding the service document to include printed news and entertainment information that is personal to the consumer.

19. A method of public printing comprising:
selectively contracting with a public printing service to print a document at a publicly accessible printer in a public venue;
posting the document to a server;
placing a mobile computing device within a select proximity of the public printer; and
sending from the mobile computing device to the public printer a security key and printing instructions to activate the public printer to retrieve the document from the server and print the document.

20. The method of claim 19, further comprising:
specifying the server to include at least one of a private server and a server of the public printing service.

21. A printing system comprising:
a server for holding a document for printing;
a printer connectable to the server;
a mobile computing device for holding a security key and printing instructions and having a communication module for activating the printer to print the document when the mobile computing device is within a select proximity of the printer.

22. The printing system of claim 21, wherein the communication module of the mobile computing device further comprises:
a wireless communication module for transmitting the security key and the printing instructions to the printer.

23. A network printing manager menu comprising:
a document identification field;
a document upload function;
a printer location; and
a security key field for identifying and activating a security key to selectively control printing of the document.

24. A printing system comprising:
a server for holding a print job;
a printer configured and arranged to receive a wireless transmission specifying a security key and printing instructions to activate the printer to access the print job from the server and print the print job.

25. A printer comprising:
a printing mechanism for printing a document;
a device independent program language reader;
a wireless communication module configured to receive a wireless transmission securely requesting printing a document on the printer wherein the transmission includes a security key and printing instructions given in device independent programming language to be implemented by the device independent program language reader.

26. The printer of claim 25, wherein the device independent program language reader further comprises a Java virtual machine and the device independent programming language further comprises Java programming language.

27. A mobile computing device comprising:
a controller; and
a wireless communication module configured for activating a printer to print a document by sending printing instructions and a security key to the printer.

28. The mobile computing device of claim 27 wherein the communication module further comprises:
an authorization module configured for recognizing the printer and configured for permitting printing of the document based on at least one of a distance of the mobile computing device relative to the printer, a time factor associated with the printer, and a type of wireless transmission associated with the printer.

29. A computer-readable medium having computer-executable instructions for performing a method of printing, the method comprising:
identifying a document for printing at a printer; and
sending from an authorized mobile computing device to the printer a security key and printing instructions to enable the printer to access and print a document.

30. The method of claim 29 and further comprising:
determining whether the mobile computing device is authorized based on at least one of a select proximity between a source of the wireless transmission and the printer, a time factor associated with the printer, and a type of wireless transmission.

31. The method of claim 29, and further comprising:
posting the document on a server as a print job for the printer; and
printing the print job only when the user activates the printer with the security key.

32. The method of claim 29, wherein the posting step further comprises:
accessing a network printing manager;
identifying the document for printing to the network printing manager; and
uploading the document to a server of the network printing manager.

33. The method of claim 29, wherein the sending step further comprises:
using a Java applet to send the printing instructions and security key to the printer.
